(19) United States
(12) Patent Application Publication
(10) Pub. No.: US 2012/0207356 A1
(43) Pub. Date: Aug. 16, 2012

(54) TARGETED CONTENT ACQUISITION USING IMAGE ANALYSIS

(76) Inventor: William A. Murphy, Los Altos, CA (US)

(21) Appl. No.: 13/369,644

(22) Filed: Feb. 9, 2012

Related U.S. Application Data
(60) Provisional application No. 61/441,422, filed on Feb. 10, 2011.

(51) Int. Cl. G06K 9/00

(52) U.S. Cl. 382/115

(57) ABSTRACT

A method comprises storing within a storage device template image data for a known individual and storing in association with the template image data an image-forwarding rule. Image data within the known field of view of the image capture system is captured and is provided to a processor, the processor in communication with the storage device. Using the processor, image analysis is performed on the captured image data to identify the known individual, based on the stored template data for the known individual. In dependence upon identifying the known individual within the captured image data, the captured image data is processed in accordance with the image-forwarding rule.

### CROSS REFERENCE TO RELATED APPLICATION

This application claims the benefit of U.S. Provisional Application No. 61/441,422, filed Feb. 10, 2011.

### FIELD OF THE INVENTION

The instant invention relates generally to image analysis, and more particularly to targeted content acquisition using image analysis.

### BACKGROUND OF THE INVENTION

Social network applications commonly refer to applications that facilitate interaction of individuals through various websites or other Internet-based distribution of content. In most social network applications a user can create an account and provide various types of content specific to the individual, such as pictures of the individual, their friends, their family, personal information in text form, favorite music or videos, etc. The content is then made available to other users of the social network application. For example, one or more web pages may be defined for each user of the social network application that can be viewed by other users of the social network application. Also, social network applications typically allow a user to define a set of “friends,” “contacts” or “members” with whom the respective user wishes to communicate repeatedly. In general, users of a social network application may post comments or other content to portions of each other's web pages.

Typically, the user's content is updated periodically to reflect the most recent or most significant occurrences in the user's life. This process involves selecting new content, editing the presentation of the existing content within one or more web pages to include the selected new content, and uploading any changes to a social network server. Of course, often it is not convenient to update content on a social network site while an event or social function is still occurring. As a result, the user's “friends” are unable to view content relating to the event or social function until some time after the event or social function has ended. The inability to interact with the user in real time, via the social networking site, may increase the feeling of alienation that the user's “friends” experience due to being unable to attend the event or social function in person. Furthermore, depending on the user's dedication to maintaining a current profile, significant time may elapse between the end of an event or social function and updating of the profile. Unfortunately, it is often the case that the “real-time value” of the captured image is lost. As a result, the user's “friends” do not realize that a particular person has entered a party or a bar, or that a beautiful sunset is occurring, etc., until after it is too late to act on that information.

It is also a common occurrence for users of social network applications to neglect to capture images during events or social functions, or to capture images that are of poor quality, etc. The user may discover after the fact that they do not have suitable images of certain people that they would like to feature in the updated content relating to a particular event or social function. At the same time, the user may inadvertently have captured images of individuals who object to being depicted on social network sites. For these reasons, even if the user is dedicated to maintaining a current profile, the result tends to be less that optimal.

Of course, images are captured for a variety of reasons other than for populating social network web pages. For instance, images are typically captured for reasons associated with security and/or monitoring. By way of a specific and non-limiting example, a parent may wish to monitor the movements of a young child within an enclosed area that is equipped with a camera system. When several children are present within the enclosed area, the captured images are likely to include images of at least some of the other children, and as a result the young child may be hidden in some of the images. Under such conditions, the parent must closely examine each image to pick out the young child that is being monitored. Another example relates to the tracking of objects in storage areas or transfer stations, etc.

Complex matching and object identification methods are known for tracking the movement of individuals or objects, such as is described in United States Patent Application Publication 2009/0245573 A1, the entire contents of which are incorporated herein by reference. Image data captured in multiple fields of view are analyzed to detect objects, and a signature of features is determined for the objects that are detected in each field of view. Via a learning process, the system compares the signatures for each of the objects to determine if the objects are multiple occurrences of the same object. Unfortunately, the system must be trained in a semi-manual fashion, and the training must be repeated for every classification of object that is to be analyzed.

It would be advantageous to provide a method and system that overcomes at least some of the above-mentioned limitations.

### SUMMARY OF EMBODIMENTS OF THE INVENTION

In accordance with an aspect of an embodiment of the invention there is provided a method comprising: storing within a storage device template image data for a known individual that is to be identified within a known field of view of an image capture system; storing in association with the template image data an image-forwarding rule; capturing image data within the known field of view of the image capture system; providing the captured image data from the image capture system to a processor, the processor in communication with the storage device; using the processor, performing image analysis on the captured image data to identify the known individual therein based on the stored template data for the known individual; and, in dependence upon identifying the known individual within the captured image data, processing the captured image data in accordance with the image-forwarding rule.

In accordance with an aspect of the invention there is provided a method comprising: storing within a storage device first template image data for use in identifying a known first individual, and storing in association with the first template image data a first image-forwarding rule; storing within the storage device second template image data for use in identifying a known second individual, and storing in association with the second template image data a second image-forwarding rule; using an image capture system, capturing image data within a known field of view of the image capture system; using a processor that is in communication with the storage device and with the image capture system, performing image analysis to identify within the captured image data the known first individual, based on the stored first template data, and to identify within the captured image data the known second individual, based on the stored second template data; and, processing the captured image data in accordance with the first image-forwarding rule and the second image-forwarding rule.

In accordance with an aspect of the invention there is provided a method comprising: retrievably storing within a storage device profile data for a known individual, the profile data comprising: template image data for use in identifying the known individual based on image analysis of captured image data; and, an image-forwarding rule specifying a destination for use in forwarding captured image data; receiving, via a communication network, captured image data; performing image analysis to identify, based on the template image data, the known individual within the captured image data; and, in dependence upon identifying the known individual within the captured image data, providing the captured image data via the communication network to the specified destination.

In accordance with an aspect of the invention there is provided a system comprising: storing within a storage device template data indicative of an occurrence of a detectable event; storing in association with the template data a forwarding rule; sensing at least one of image data and audio data using a sensor having a sensing range; providing the sensed at least one of image data and audio data from the sensor to a processor, the processor in communication with the storage device; using the processor, comparing the sensed at least one of image data and audio data with the stored template data; and, when a result of the comparing is indicative of an occurrence of the detectable event, processing the sensed at least one of image data and audio data in accordance with the forwarding rule.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a schematic block diagram of a system according to an embodiment of the instant invention;

FIG. 2 is a schematic block diagram of another system according to an embodiment of the instant invention;

FIG. 3 is a simplified flow diagram of a method according to an embodiment of the instant invention;

FIG. 4 is a simplified flow diagram of a method according to an embodiment of the instant invention; and,

FIG. 5 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

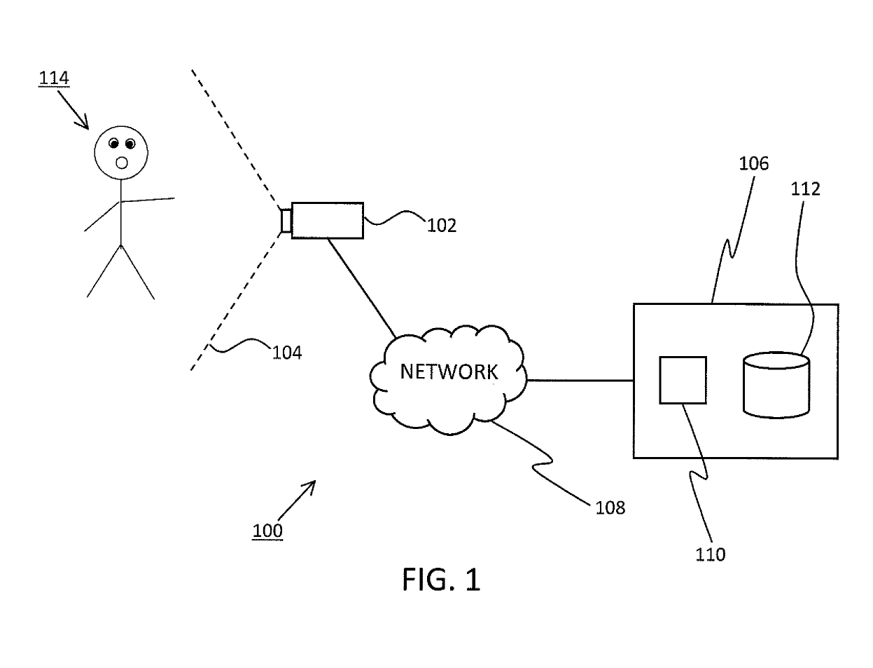

FIG. 1 is a simplified block diagram of a system according to an embodiment of the instant invention. The system 100 comprises an image capture system comprising a camera 102 for capturing image data within a known field of view (FOV) 104. The system 100 further comprises a server 106 that is remote from the camera 102, and that is in communication with the camera 102 via a communication network 108, such as for instance a wide area network (WAN). The server 106 comprises a processor 110 and a data storage device 112. The data storage device 112 stores template data for a known individual 114 that is to be identified within the FOV 104. In addition, the data storage device stores in association with the template data a defined image-forwarding rule. For instance, a profile for the known individual 114 is defined including the template data and the defined image-forwarding rule. Optionally, the profile for the known individual 114 comprises criteria for modifying the image-forwarding rule, or comprises a plurality of image forwarding rules in a hierarchal order.

Optionally, the camera 102 is one of a video camera that captures images substantially continuously, such as for instance at a frame rate of between 5 frames per second (fps) and 30 fps, and a “still” camera that capture images at predetermined intervals of time or in response to an external trigger. Some specific and non-limiting examples of suitable external triggers include detection of motion within the camera FOV 104, detection of infrared signal and resulting triggering of light, and user-initiated actuation of an image capture system.

During use, the camera 102 captures image data within the known FOV 104 and provides the captured image data to the processor 110 of server 106 via the network 108. Using the processor 110, an image analysis process is applied to the captured image data for identifying the known individual 114 therein, based on the template data stored within storage device 112. For instance, the template data comprises recognizable facial features of the known individual 114, and the image analysis process is a facial recognition process. Optionally, the captured image data comprises a stream of video data captured using a video camera, and the image analysis is a video analytics process, which is performed in dependence upon image data of a plurality of frames of the video data stream.

When the image analysis process identifies the known individual 114 in the captured image data, the image-forwarding rule that is stored in association with the template data is retrieved from the data storage device 112. The captured image data is then processed according to the image-forwarding rule.

In a first specific and non-limiting example, the image-forwarding rule includes a destination and an authorization for forwarding to the destination the captured image data within which the known individual 114 is identified. In this case, the known individual 114 does not object to being represented in the image data that is provided to the destination, which is for instance a social networking application or another publicly accessible destination.

Optionally, the specified destination is an electronic device associated with the known individual 114, such as for instance a server, a personal computer or a portable electronic device, etc. In this variation, captured image data is provided to a publicly inaccessible destination, allowing the known individual 114 ultimately to control the dissemination of the image data.

In a second specific and non-limiting example, the image-forwarding rule includes a forwarding criterion. For instance, the forwarding criterion comprises a time delay between capturing the image data and forwarding the image data to the destination. In this case, the known individual 114 does not object to being represented in image data that is provided to the destination, which is for instance a social networking application or another publicly accessible destination. The known individual 114 does however require a time delay between capturing the image data and making the image data publicly available. In this way, a celebrity such as an actor, a sports figure or a political figure may be given sufficient time to leave a particular area before the images showing the celebrity in that area become publicly available. Thus, a restaurant or another venue may capture promotional images while the celebrity is present and identify a subset of captured images that include the celebrity, using image analysis based on template data that is stored with a profile for that celebrity. The subset of captured images is then either stored locally during the specified time delay, or provided to the destination but not made publicly accessible until after the end of the specified time delay. In this case, the restaurant or venue is able to provide the promotional images for public viewing in a timely manner, while at the same time respecting the privacy of the celebrity. Alternatively, the time delay allows the celebrity or another entity to approve/modify/reject placement of the images on the social networking application or other publicly accessible destination. In this way, unflattering images or images showing inappropriate social behavior may be removed.

In a third specific and non-limiting example, the image-forwarding rule comprises a forwarding denial instruction. In this case, the known individual 114 objects to being represented in image data that is provided to the destination, which is for instance a social networking application or another publicly accessible destination. When the image-forwarding rule comprises a forwarding denial instruction, image data containing the known individual 114 is not forwarded to a destination, such as for instance a social networking application. Of course, other image-forwarding rules may be defined and included in the profile for the known individual 114.

In addition, the system that is shown in FIG. 1 may be used in connection with other applications, such as for instance security monitoring. In this case, a profile is defined for each authorized individual, such as for instance a security guard or a building tenant. When image analysis performed on captured image data identifies the authorized individual within a captured image, based on template data that are stored with the authorized individual's profile, no action is taken to provide the image data to a security center as part of a security alert, in accordance with a defined image-forwarding rule that is stored with the authorized user's profile. Optionally, the defined image-forwarding rule specifies additional criteria, such as for instance time periods during which the authorized individual is authorized to be within the monitored area. In the event that camera 102 captures an image of the authorized individual outside of the authorized time periods, an alert may be sent to the security center. Additionally, image data may be sent to the security center when the image analysis process fails to identify an individual within a captured image, or when an identification confidence score is below a predetermined threshold value.

In an alternative embodiment, camera 102 is edge device and includes an on-board image analysis processor and a memory for storing a profile including template data and image-forwarding rules in association with an indicator of the known individual 114. Optionally, the on-board image analysis processor performs image analysis, such as for instance video analytics processing, to identify the known individual 114 within captured image data, and then processes the captured image data in accordance with the defined image-forwarding rule. Further optionally, the on-board image analysis merely pre-identifies at least one known individual 114 within the captured image data, and the pre-identified captured image data is then provided to server 106 for additional image analysis. Optionally, the on-board image analysis qualifies the captured image data for secondary processing, based on identified gender, age, height, body type, clothing color, etc. of the at least one known individual 114. For instance, image analysis processes in execution on server 106 detect other individuals within the captured image data, whether they are known individuals or not, and identifies the detected individuals that are known based on stored template data. Optionally, image analysis processes in execution on server 106 determine quality factors and compare the determined quality factors to predetermined threshold values. Optionally, when multiple known individuals are identified within the same captured image data, processor 110 resolves conflicts arising between the defined rules for different known individuals. For instance, the captured image data is cropped so as to avoid making public an image of an individual having a profile including a forwarding denial instruction.

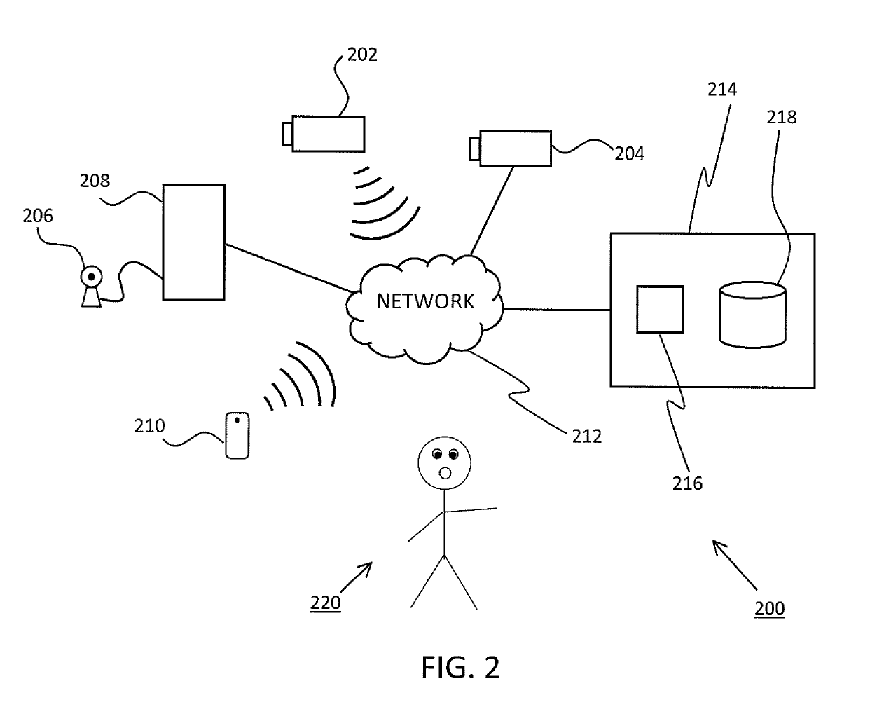

FIG. 2 is a simplified block diagram of another system according to an embodiment of the instant invention. The system 200 comprises a plurality of cameras, such as for instance a first network camera 202, a second network camera 204, a “web cam” 206 associated with a computer 208, and a camera phone 210. Each camera 202, 204, 206 and 210 of the plurality of cameras is associated, at least temporarily, with a first user. For instance, in the instant example the first network camera 202, the second network camera 204 and the “web cam” 206 belong to a first user and are disposed within the first user's location, whereas the camera phone 210 belongs to a second user who is at the first user's location only temporarily. Optionally, some cameras of the plurality of cameras are stationary, such as for instance the second network camera 204 and the “web cam” 206, whilst other cameras of the plurality of cameras are either mobile or repositionable (pan/tilt/zoom, etc.), such as for instance the camera phone 210 and the first network camera 202, respectively. Further optionally, the plurality of cameras includes video cameras that capture images substantially continuously, such as for instance at a frame rate of between 5 frames per second (fps) and 30 fps, and/or “still” cameras that capture images at predetermined intervals of time or in response to an external trigger. Some specific and non-limiting examples of suitable external triggers include detection of motion within the camera field of view (FOV) and user-initiated actuation of an image capture system.

Each camera 202, 204, 206 and 210 of the plurality of cameras is in communication with a communication network 212 via either a wireless network connection or a wired network connection. In an embodiment, the communication network 212 is a wide area network (WAN) such as for instance the Internet. Optionally, the communication network 212 includes a local area network (LAN) that is connected to the WAN via a not illustrated gateway. Further optionally, the communication network 212 includes a cellular network.

During use, the plurality of cameras 202, 204, 206 and 210 capture image data relating to individuals or other features within the respective FOV of the different cameras. When the plurality of cameras 202, 204, 206 and 210 are separated spatially one from another, for instance the cameras 202, 204, 206 and 210 are located in different rooms or different zones at the first user's location, then image data relating to different individuals may be captured simultaneously. Alternatively, image data relating to a particular individual 220 may be captured at different times as that individual 220 moves about the first user's location and passes through the FOV of the different cameras 202, 204, 206 and 210.

Referring still to FIG. 2, the system 200 further includes an image analysis server 214, such as for instance a video analytics server, comprising a processor 216 and a data storage device 218. The server 214 is in communication with the plurality of cameras via the communication network 212. The data storage device 218 stores template data for a known individual 220 that is to be identified within the FOV of one of the cameras 202, 204, 206 and 210. In addition, the data storage device stores in association with the template data a defined image-forwarding rule. For instance, a profile for the known individual 220 is defined including the template data and the defined image-forwarding rule. Optionally, the profile for the known individual 220 comprises criteria for modifying the image-forwarding rule, or comprises a plurality of image forwarding rules in a hierarchal order.

Optionally, the cameras 202, 204, 206 and 210 include at least one of a video camera that captures images substantially continuously, such as for instance at a frame rate of between 5 frames per second (fps) and 30 fps, and a “still” camera that captures images at predetermined intervals of time or in response to an external trigger. Some specific and non-limiting examples of suitable external triggers include detection of motion within the camera FOV, use of passive infrared (PIR) sensor to trigger a light and capture an image, and user-initiated actuation of an image capture system.

During use, at least one of the cameras 202, 204, 206 and 210 captures image data within the respective FOV thereof, and provides the captured image data to the processor 216 of server 214 via the network 212. Using the processor 216, an image analysis process is applied to the captured image data for identifying the known individual 220 therein, based on the template data stored within storage device 218. For instance, the template data comprises recognizable facial features of the known individual 220 taken from different points of view and at different instants, typically 12-20, and the image analysis process is a facial recognition process. Optionally, the captured image data comprises a stream of video data captured using a video camera, and the image analysis is a video analytics process, which is performed in dependence upon image data of a plurality of frames of the video data stream.

When the image analysis process identifies the known individual 220 in the captured image data, the image-forwarding rule that is stored in association with the template data is retrieved from the data storage device 218. The captured image data is then processed according to the image-forwarding rule.

In a first specific and non-limiting example, the image-forwarding rule includes a destination and an authorization for forwarding to the destination the captured image data within which the known individual 220 is identified. In this case, the known individual 220 does not object to being represented in the image data that is provided to the destination, which is for instance a social networking application or another publicly accessible destination.

Optionally, the specified destination is an electronic device associated with the known individual 220, such as for instance a server, a personal computer or a portable electronic device, etc. In this variation, captured image data is provided to a publicly inaccessible destination, allowing the known individual 220 ultimately to control the dissemination of the image data.

In a second specific and non-limiting example, the image-forwarding rule includes a forwarding criterion. For instance, the forwarding criterion comprises a time delay between capturing the image data and forwarding the image data to the destination. In this case, the known individual 220 does not object to being represented in image data that is provided to the destination, which is for instance a social networking application or another publicly accessible destination. The known individual 220 does however require a time delay between capturing the image data and making the image data publicly available. In this way, a celebrity such as an actor, a sports figure or a political figure may be given sufficient time to leave a particular area before the images showing the celebrity in that area become publicly available. Thus, a restaurant or another venue may capture promotional images while the celebrity is present and identify a subset of captured images that include the celebrity, using image analysis based on template data that is stored with a profile for that celebrity. The subset of captured images is then either stored locally during the specified time delay, or provided to the destination but not made publicly accessible until after the end of the specified time delay. In this case, the restaurant or venue is able to provide the promotional images for public viewing in a timely manner, while at the same time respecting the privacy of the celebrity. Alternatively, the time delay allows the celebrity or another entity to approve/modify/reject placement of the images on the social networking application or other publicly accessible destination. In this way, unflattering images or images showing inappropriate social behavior may be removed.

Alternatively, the forwarding criterion is based on a current situation or location of the known individual 220. For instance, the forwarding criterion may specify that only those images that are captured in public places are forwarded, while images that are captured in private places are not forwarded.

In a third specific and non-limiting example, the image-forwarding rule comprises a forwarding denial instruction. In this case, the known individual 220 objects to being represented in image data that is provided to the destination, which is for instance a social networking application or another publicly accessible destination. When the image-forwarding rule comprises a forwarding denial instruction, image data containing the known individual 220 is not forwarded to a destination, such as for instance a social networking application. Of course, other image-forwarding rules may be defined and included in the profile for the known individual 220.

In addition, the system that is shown in FIG. 2 may be used in connection with other applications, such as for instance security monitoring. In this case, a profile is defined for each authorized individual, such as for instance a security guard or a building tenant. When image analysis performed on captured image data identifies the authorized individual within a captured image, based on template data that are stored with the authorized individual's profile, no action is taken to provide the image data to a security center as part of a security alert, in accordance with a defined image-forwarding rule that is stored with the authorized user's profile. Optionally, the defined image-forwarding rule specifies additional criteria, such as for instance time periods during which the authorized individual is authorized to be within the monitored area. In the event that one of the cameras 202, 204, 206 and 210 captures an image of the authorized individual outside of the authorized time periods, an alert may be sent to the security center. Additionally, image data may be sent to the security center when the image analysis process fails to identify an individual within a captured image, or when an identification confidence score is below a predetermined threshold value.

In an alternative embodiment, at least one of the cameras 202, 204, 206 and 210 is an edge device and includes an on-board image analysis processor and a memory for storing a profile including template data and image-forwarding rules in association with an indicator of the known individual 220. Optionally, the on-board image analysis processor performs image analysis, such as for instance video analytics processing, to identify the known individual 220 within captured image data, and then processes the captured image data in accordance with the defined image-forwarding rule. Further optionally, the on-board image analysis merely pre-identifies at least one known individual 220 within the captured image data, and the pre-identified captured image data is then provided to server 214 for additional image analysis. For instance, image analysis processes in execution on server 214 detects other individuals within the captured image data, whether they are known individuals or not, and identifies the detected individuals that are known based on stored template data. Optionally, image analysis processes in execution on server 214 determine quality factors and compare the determined quality factors to predetermined threshold values. Optionally, when multiple known individuals are identified within the same captured image data, processor 216 resolves conflicts arising between the defined rules for different known individuals. For instance, the captured image data is cropped so as to avoid making public an image of an individual having a profile including a forwarding denial instruction.

In an embodiment, the image analysis server 106 or 214 is “in the cloud” and performs image analysis, such as for instance video analytics functions, for a plurality of different users including the first user. Accordingly, image data transmitted from the camera 102 or from the plurality of cameras 202, 204, 206, 210 includes a unique identifier that is associated with the first user.

As a person having ordinary skill in the art will appreciate, cameras are being installed in public spaces in increasing numbers, and the cameras that are being installed today are capable of capturing high resolution, high quality images. For the most part, individuals are not aware that their images are being captured as they go about their daily routines. That being said, such individuals in an urban setting may be imaged dozens or even hundreds of times every day. Often, the captured image data is archived until there is a need to examine it, such as for instance subsequent to a security incident. Of course, the vast majority of the image data that is collected does not contain any content that is of significance in terms of security, and therefore it is not reviewed. On the other hand, at least some of the image data that is collected may be of significance to the individuals that have been imaged. For instance, by chance one of the thousands of cameras that are installed in public spaces, parks, shopping malls, businesses, restaurants, along sidewalks, in stairwells etc. may happen to capture image data during a moment of a day, which an individual considers to be particularly memorable, enjoyable or significant. In one specific and non-limiting example, cameras at a sporting event, such as for instance a National Hockey League playoff game, capture images of a known individual, etc.

Accordingly, in one specific application of the system of FIG. 2, the plurality of cameras 202, 204, 206 and 210 and a plurality of other cameras are coupled to the network 212 and provide captured image data to a “clearinghouse” server 214. Optionally, at least some of the plurality of cameras 202, 204, 206 and 210 are edge devices capable of performing image analysis, such as for instance video analytics. In that case, the edge devices perform video analytics to identify portions of the captured image data that are of potential interest. As such, captured image data are not provided to the server 214 when there are no individuals within the FOV of the camera. In order to reduce the amount of video data that is transmitted via the network 212, optionally the video analytics process identifies segments of video data, or individual frames of image data, that are of sufficiently high quality to be forwarded to the server 214. For instance, rules may be established such that video data or individual frames of image data are forwarded to the server 214 only if the individual detected in the image data is in focus, or if the detected individual's face is fully shown, or if the detected individual is fully clothed, etc.

An image analysis process that is in execution on processor 216 of server 214 identifies the detected individual in the image data, based on template data stored within storage device 218 in association with profiles for known individuals. In one implementation, the system is subscription based and individuals establish a profile including template image data, and at least an image-forwarding rule. Accordingly, once the individual is identified based on the stored template data, the image data is processed in accordance with the image-forwarding rule. In one specific and non-limiting example, the image-forwarding rule specifies forwarding the image data automatically to a destination, such as for instance a social networking application. Since the location and time is known for each captured image, this example supports the automated posting of image data as the individual goes about their daily routine. Alternatively, the image-forwarding rule specifies forwarding the image data automatically to a destination that is associated with the individual, such as for instance a portable electronic device or a personal computer, etc. The individual may then screen the images before the images are made publicly available. Alternatively, the image-forwarding rule specifies forwarding the image data automatically to a destination that is associated with a second individual, such as for instance a portable electronic device or a personal computer, etc. In this case, the second individual may “spy” on the individual that is identified based on the template data of the profile. For instance, a parent may provide template data for their child and receive images of their child, the images being captured by various cameras installed in public places that the child may, or may not, be permitted to visit.

Further optionally, an individual establishes a profile including schedule data in addition to the template data and image-forwarding rule. In this way, the server 214 may actively request image or video data that is captured by public cameras along the scheduled route. Optionally, the server requests all of the video data or image data that is captured within a known period of time, based on the schedule data.

Further optionally, previously captured and archived image data is processed subsequent to the known individual establishing a profile. In this way, the known individual may receive image or video data that was captured days, weeks, months or even years earlier. This may allow the known individual to obtain, after the fact, image data or video data relating to past events or to other individuals, including other individuals that may have grown up, moved away, or died, etc.

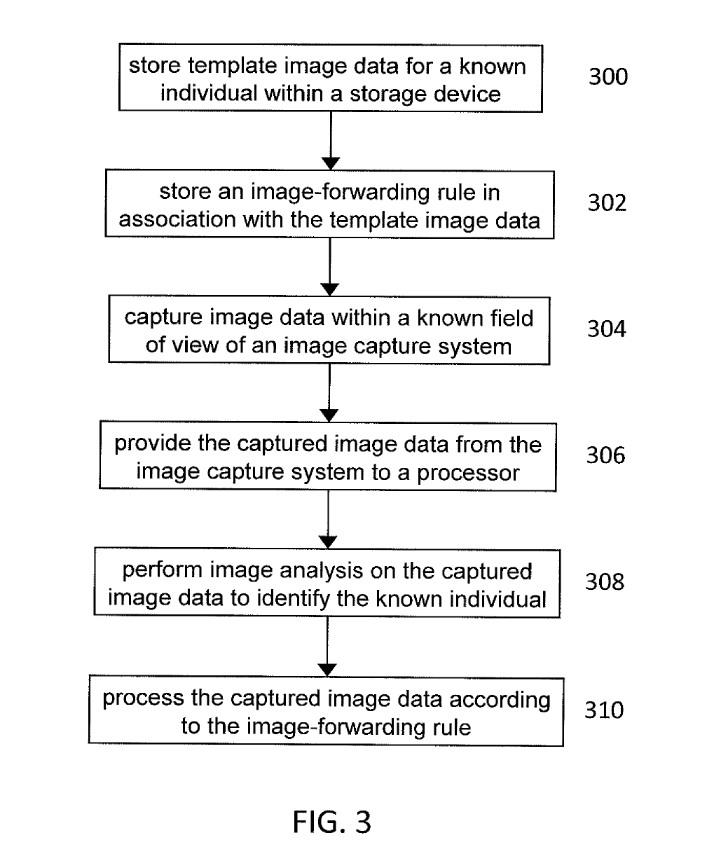

Referring now to FIG. 3, shown is a simplified flow diagram of a method according to an embodiment of the instant invention. At 300, template image data for a known individual that is to be identified within a known field of view of an image capture system is stored within a storage device. At 302 an image-forwarding rule is storied in association with the template image data. At 304 image data is captured within the known field of view of the image capture system. At 306 the captured image data is provided from the image capture system to a processor, the processor in communication with the storage device. At 308, using the processor, image analysis is performed on the captured image data to identify the known individual therein, based on the stored template data for the known individual. At 310, in dependence upon identifying the known individual within the captured image data, the captured image data is processed in accordance with the image-forwarding rule.

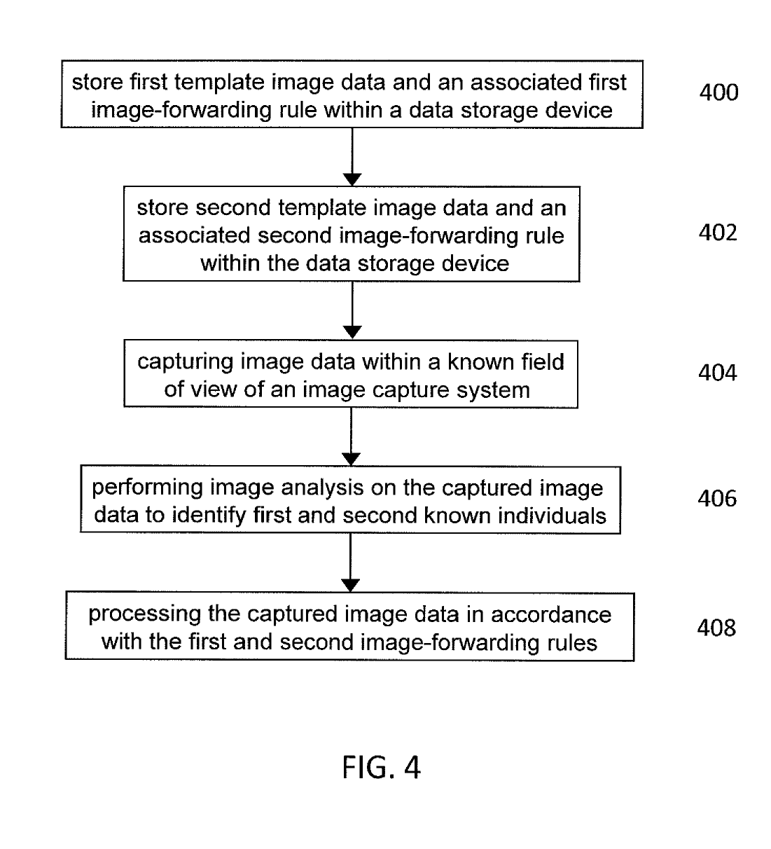

Referring now to FIG. 4, shown is a simplified flow diagram of a method according to another embodiment of the instant invention. At 400 first template image data, for use in identifying a known first individual, is stored within a storage device. A first image-forwarding rule is stored in association with the first template image data. At 402 second template image data, for use in identifying a known second individual, is stored within the storage device. A second image-forwarding rule is stored in association with the second template image data. At 404, using an image capture system, image data is captured within a known field of view of the image capture system. At 406, using a processor that is in communication with the storage device and with the image capture system, image analysis is performed to identify within the captured image data the known first individual, based on the stored first template data, and to identify within the captured image data the known second individual, based on the stored second template data. At 408, the captured image data is processed in accordance with the first image-forwarding rule and the second image-forwarding rule.

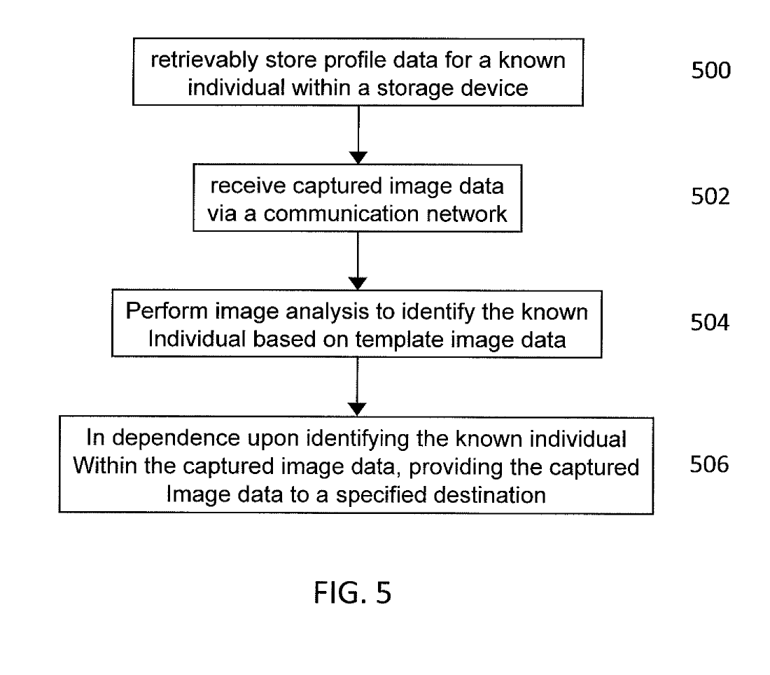

Referring now to FIG. 5, shown is a simplified flow diagram of a method according to an embodiment of the instant invention. At 500 profile data for a known individual is retrievably stored within a storage device. The profile data comprises i) template image data for use in identifying the known individual based on image analysis of captured image data; and, ii) an image-forwarding rule specifying a destination for use in forwarding captured image data. At 502 captured image data is received via a communication network. At 504 image analysis is performed to identify, based on the template image data, the known individual within the captured image data. At 506, in dependence upon identifying the known individual within the captured image data, the captured image data is provided via the communication network to the specified destination.

In addition to identifying known individuals, the systems described with reference to FIGS. 1 and 2 may be used for automatically identifying a variety of events based on comparing sensed image data and/or sensed audio data with stored template data. By way of a specific and non-limiting example, sensed image data and sensed audio data are used to identify an occurrence of an explosion within a sensing range of a sensor. For instance, the template data includes template image data indicative of debris scattered on the road and template audio data indicative of a loud blast sound. To this end, at least one of template image data and template audio data are stored within a storage device, the template data indicative of an occurrence of a detectable event, such as for instance an explosion. In addition, a forwarding rule is stored in association with the template data. Using a sensor having a sensing range, at least one of image data and audio data are sensed within the sensing range. The sensed at least one of image data and audio data are provided from the sensor to a processor, the processor in communication with the storage device. Using the processor, the sensed at least one of image data and audio data are compared with the stored template data. When a result of the comparing is indicative of an occurrence of the detectable event, the sensed at least one of image data and audio data is processed in accordance with the forwarding rule. For instance, the forwarding rule comprises an indication of a destination and an authorization for forwarding to the destination the captured image data. By way of a specific and non-limiting example, the destination is one or more of a security monitoring service, local police, local fire department, local ambulance service, etc.

Numerous other embodiments may be envisaged without departing from the scope of the invention.

What is claimed is:

1. A method comprising:
storing within a storage device template image data for a known individual that is to be identified within a known field of view of an image capture system;
storing in association with the template image data an image-forwarding rule;
capturing image data within the known field of view of the image capture system;
providing the captured image data from the image capture system to a processor, the processor in communication with the storage device;
using the processor, performing image analysis on the captured image data to identify the known individual therein based on the stored template data for the known individual; and,
in dependence upon identifying the known individual within the captured image data, processing the captured image data in accordance with the image-forwarding rule.

2. A method according to claim 1, wherein the image-forwarding rule comprises an indication of a destination and an authorization for forwarding to the destination the captured image data.

3. A method according to claim 2, wherein the image-forwarding rule comprises a forwarding criterion.

4. A method according to claim 3, wherein the forwarding criterion comprises a time delay between capturing the image data and forwarding the image data to the destination.

5. A method according to claim 2, wherein the destination is a social networking application.

6. A method according to claim 2, wherein the destination is one of an advertisement-placement targeting engine and a market demographic compiling engine.

7. A method according to claim 1, wherein the image capture system comprises a first image capture device and a second image capture device, and wherein capturing image data within the known field of view of the image capture system comprises capturing first image data within a first field of view of the first image capture device and capturing second image data within a second field of view of the second image capture device.

8. A method according to claim 7, wherein performing image analysis on the captured image data to identify the known individual comprises performing image analysis on the captured first image data and performing image analysis on the captured second image data.

9. A method according to claim 8, wherein the image-forwarding rule comprises an indication of a destination, an authorization for forwarding to the destination the captured first image data and the captured second image data, and an instruction for including a first time stamp and a first location with the first image data based on a first time of capture and a first location of the first image capture device and for including a second time stamp and a second location with the second image data based on a second time of capture and a second location of the second image capture device.

10. A method according to claim 1, wherein the processor is remote from the image capture system, and wherein the captured image data is provided from the image capture system to the processor via a communication network.

11. A method according to claim 1, wherein performing image analysis depends on image data of a plurality of frames of a video data stream.

12. A method according to claim 1, wherein performing image analysis depends on image data comprising a combination of a still image frame and a burst of video frames.

13. A method according to claim 1, wherein the template data is facial feature template data, and wherein the image analysis is a facial recognition process.

14. A method comprising:
storing within a storage device first template image data for use in identifying a known first individual, and storing in association with the first template image data a first image-forwarding rule;
storing within the storage device second template image data for use in identifying a known second individual, and storing in association with the second template image data a second image-forwarding rule;
using an image capture system, capturing image data within a known field of view of the image capture system;
using a processor that is in communication with the storage device and with the image capture system, performing image analysis to identify within the captured image data the known first individual, based on the stored first template data, and to identify within the captured image data the known second individual, based on the stored second template data; and,
processing the captured image data in accordance with the first image-forwarding rule and the second image-forwarding rule.

15. A method according to claim 14, wherein processing the captured image data comprises forwarding the captured image data via the communication network to a destination when the first image-forwarding rule and the second image-forwarding rule each comprise an indication of the destination and an authorization for forwarding the captured image data to the destination.

16. A method according to claim 14, wherein processing the captured image data comprises:
when the first image-forwarding rule comprises a forwarding denial instruction, cropping a first portion of the captured image data containing the known first individual; and,
when the second image-forwarding rule comprises an indication of a destination and an authorization for forwarding the captured image data to the destination, forwarding a second portion of the captured image data containing the second known individual via the communication network to the destination.

17. A method according to claim 14, wherein performing image analysis depends on image data of a plurality of frames of a video data stream.

18. A method comprising:
retrievably storing within a storage device profile data for a known individual, the profile data comprising:
template image data for use in identifying the known individual based on image analysis of captured image data; and,
an image-forwarding rule specifying a destination for use in forwarding captured image data;
receiving, via a communication network, captured image data;
performing image analysis to identify, based on the template image data, the known individual within the captured image data; and,
in dependence upon identifying the known individual within the captured image data, providing the captured image data via the communication network to the specified destination.

19. A system comprising:
an image capture system for capturing image data within a known field of view;
a storage device having stored therein profile data relating to a known individual, the profile data comprising template image data for use in identifying the known individual within captured image data and an image-forwarding rules that is stored in association with the template image data; and,
a processor in communication with the image capture system for receiving captured image data from the image capture system and for performing image analysis on the image data to identify the known individual within the captured image data based on the template data.

20. A system according to claim 19, wherein the processor is remote from the image capture system, and wherein the processor is in communication with the image capture system via a communication network.

21. A system according to claim 19, wherein the image capture system comprises a first image capture device and a second image capture device, the first image capture device for capturing image data within a first known field of view and the second image capture device for capturing image data within a second known field of view.

22. A system according to claim 19, wherein the image capture system comprises a video camera for capturing a plurality of frames of image data and for providing the captured plurality of frames of image data as a video data stream.

23. A system according to claim 22, wherein during use the processor has in execution thereon a video analytics process for performing image analysis in dependence on image data of the plurality of frames of the video data stream.

24. A method comprising:
storing within a storage device template data indicative of an occurrence of a detectable event;
storing in association with the template data a forwarding rule;
sensing at least one of image data and audio data using a sensor having a sensing range;
providing the sensed at least one of image data and audio data from the sensor to a processor, the processor in communication with the storage device;
using the processor, comparing the sensed at least one of image data and audio data with the stored template data; and,
when a result of the comparing is indicative of an occurrence of the detectable event, processing the sensed at least one of image data and audio data in accordance with the forwarding rule.

25. A method according to claim 24, wherein the image-forwarding rule comprises an indication of a destination and an authorization for forwarding to the destination the captured image data.
